(19) United States
(12) Patent Application Publication
(10) Pub. No.: US 2007/0119854 A1
(43) Pub. Date: May 31, 2007

(54) Paint bucket

(76) Inventor: Jean Victoria Rittmann, Everett, WA (US)

Correspondence Address: Jean V. Rittmann, 2016 Broadway Ave., Everett, WA, 98201-2318, US

(21) Appl. No.: 11/286,975

(22) Filed: Nov. 28, 2005

(51) Int. Cl. B05C 21/00

(52) U.S. Cl. 220/570

(57) ABSTRACT

This invention is an injection-moldable, substantially rectangular lipped paint bucket, with opposite-side, substantially parallel-edged ledges, ledges formed from the walls beneath the rectangles shorter sides. The first ledge is substantially 0.5 to 0.7″ down from the bucket lip. the second ledge is substantially 2″ down from the bucket lip. These lips are formed substantially as upside-down L-shaped indentations in the bucket sides under rectangle shorter sides. Each ledge edge protrudes substantially 1″ into the bucket, and is substantially 6″ wide. The first ledge is for brush wiping below the bucket lip. The second ledge, along with the bucket lip on the opposite side, is for brush support. The second ledge doubles as a handle.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

This invention relates to receptacles with container attachment or adjunct. More specifically, to receptacles (paint buckets) including edge for removing excess material (i.e. scraper) with tool or brush holder.

Paint buckets up till now have almost always been needed/used in some fashion for brush dipping, brush wiping, and brush holding. It is desirous to comfortably hold or support a bucket while in use. It is desirous to compactly stack buckets to reduce shipping costs and shelf space. Additionally pouring from and sealing a bucket would be benefits. It is a crowded art, yet prior art buckets have not yet fulfilled all these basic needs with a single bucket.

Round (at lip and base) buckets are common prior art. Perhaps most buckets were round because metal-formed cans and buckets were easiest to make round, perhaps many expect them to be round. However, round-lipped containers limit the dipping area of paint brushes, which are flat-sided. This problem is most obvious when one tries to dip a 4″ wide brush in a 1 gallon paint can that averages a 5.5″ inside diameter: The brush virtually has to be dipped straight down from the top of such a can, which likely requires sitting a can down. Often when painting, sitting a can down on a stable surface while painting is not an option. One can tilt the can, gripping the wire handle-and-cans-side, but this is only bearable if the can is mostly empty. Wiping a flat-sided brush on a round rim leaves the brush with an uneven load of paint. Often one tries to wipe nearly horizontal to more evenly wipe paint, but this often leaves paint in the sealing groove. Laying the brush on a cans top lip drips paint out of the bucket, leaves the lip groove full of paint, gets the handle messy with paint, and is not always a secure place for the brush. Cleaning the groove for a good can seal is very time-consuming.

Noted is U.S. Pat. No. 3,595,431 by Francis L. Bird, granted Jul. 27, 1971, entitled DRIPLESS PAINT CONTAINER, which shows a circular-lipped container. In his abstract he states, “molded plastic paint container” with “two snap-on wire rods in diametrically opposed parallel relation to serve as wipers for the brushes enabling drainage of excess paint therefrom without any spillage. These rods also serve as shelves on which to rest the brush or brushes when not in use.” P. 1, lines 2-3, he states,“its principal object . . . low cost”.

Wire rods in his plastic bucket requires additional labor and expense beyond a basic bucket. Such rods (if not made of expensive stainless steel) can eventually rust (with latex paint) even if galvanized, as wiping is surface-abrasive. Also, a latex paint manufacturer could not sell their product in such a bucket because of the rustable rods. Because the container has a substantially round lip and base, the inside rods further restrict the usable dipping area. Though Francis does not state size, his drawing FIG. 3 shows his bucket with a brush (an average house paint brush is 10″ to 11.5″ long). So his bucket has an approximate 8″ diameter lip and 6″ diameter base, which is an average size for a one gallon paint pail. His bucket in use is drawn in PRIOR ART FIGS. X1, a front view. To use the rods as wipers/brush shelf, his container could only contain (below wipers) perhaps ¾ gallon. The rods, at center, extend about 1″ into the container. (Rod length is around 4″, likely to allow wiping of up to a 4″ brush.) [If the rods were longer they would really restrict the container area for dipping.] A 4″ brush could be wiped (though one would have to pay attention that it is centered on the rod). Tipping the bucket to dip (to get the last of the paint) in his bucket requires maneuvering around the closest rod. A smaller disadvantage is with a buckets metal handle. Because the handle must lay close to the bucket side when not in use, the handle is not very tall when used to hang the bucket. In fact, it is short enough to further restrict the area available for brush dipping. The handle is curved at the top, which is not a comfortable design for a hand that holds it.

A greater problem arises if his rods are used as a brush shelves. This is depicted in my redrawing of his FIG. 2 as my PRIOR ART FIG. X2, top view. A 4″ brush and a 2″ brush are drawn. Note that a 4″ brush could not stay on his ledge, because the containers curved walls pushes it to the brush tip. Brushes have flex, and a heavy wet brush nearly requires a full inch of support at the tip to not fall off. Even a 2″ wide brush will barely stay on his ledge with only about 0.5″ of support. Some bristles can split off below the rod. Though only about 1″ into the bucket, the rods restrict the brush dipping area. His container leaves substantially a 6″ rectangular-like area from which to dip a brush, only slightly larger than a gallon paint can. However, if the rods were inside far enough to hold a brush the buckets dipping area would be 4″, which would be uncomfortable to maneuver around (see vertical phantom lines).

U.S. Pat. No. 4,927,046 by Robert E. Armstrong, granted May. 23, 1990, entitled HOLDING VESSEL WITH SUPPORTIVE HANDLE provides a ledge designed to hold a brush securely. He has chosen a pentagonal shape in effort to elongate the container to hold a brush from handle ledge to handle. However the pentagonal shape makes brush wiping on a lip difficult, because a user is comfortable wiping straight in, where his FIG. 1 ¾ center spout/notch is. A painter would either accidentally drip paint out where that notch is or would have to cock their wrist to wipe it on the closer ledge. Though Armstrong comments (P. 3, lines 67-68), “The spouts 3 are further adaptable to pouring liquids accurately”, the somewhat capillary action of the notch actually holds paint at the edge causing drips. The center spout notch also reduces the likelihood that a lid could seal the vessel. The small weight of his vessel filled with paint is of advantage, as the sharp edges of FIG. 4 handle 2 (needed for strength) would dig more into a users hand when gripped. Holding a container on its side (like his) requires much more effort and twist-wrist strain than hanging a vessel or tilt/grabbing it near its lip. Armstrongs handle requires his vessel to be made of a 3-part mold (2 sides of handle/vessel, and interior cavity/core). Adding a slide to a tool adds expense.

Though paint brushes are rectangular, and a rectangular container would more easily avail paint for use, both Armstrong and Bird teach away from that shape, perhaps because round shaped containers have almost always been used for painting with brushes. (A pentagonal shape is substantially round compared to a rectangular shape). Prior art rectangular-lipped molded plastic containers include plastic food containers, and some bathroom wastebaskets. Rectangular-lipped food containers with rounded corners allow for a secure seal with a lid.

Most importantly, Bird and Armstrong's containers cannot be stacked sufficiently one-inside another to reduce space. That is, buckets are low ticket items, so large quantities must take up a minimal amount of space when shipped and shelved in stores. Bird's bucket, even if rods were shipped separately, cannot be stacked one closely inside another because of the rod supports. Armstrong's handle prevents stacking of his container.

### BRIEF SUMMARY OF THE INVENTION

This invention is an injection-moldable, substantially rectangular lipped paint bucket, with opposite-side, substantially parallel-edged ledges, ledges formed from the walls beneath the rectangles shorter sides. The first ledge is substantially 0.5 to 0.7″ down from the bucket lip. the second ledge is substantially 2″ down from the bucket lip. These lips are formed substantially as upside-down L-shaped indentations In the bucket sides under rectangle shorter sides. Each ledge edge protrudes substantially 1″ into the bucket, and is substantially 6″ wide. The first ledge is for brush wiping below the bucket lip. The second ledge, along with the bucket lip on the opposite side, is for brush support. The second ledge doubles as a handle.

### ADVANTAGES OF THE INVENTION

The first ledge lets a painter wipe a brush slightly down from the lip, to keep the lip clean for a lid or brush handle. The ledge is wide enough to wipe even a 4″ brush without paying much attention. The ledge tilts to allow paint to drip back into the bucket. One can pour paint from that sides corners.

The second ledge is wide and deep enough to easily lay even 4″ wide brushes. It is down about 1.75″ to 2″ to lay a brush bristles in the bucket without dripping paint outside the bucket. (Brush handle lays on opposite-side bucket lip.) Its top portion is either flat or declines away from the buckets center to help keep the brush from slipping off.

The buckets rectangular shaped lip and body, easily allows a wide (like 4″) brush to be dipped while holding the buckets handle (bucket tilting unnecessary). The bucket can also be tilted (to get the last of the paint) by grabbing under the second ledge and above the same-side lip, like a handle. An average bucket can hold a gallon of paint below the lowest ledge (so it is always useable). Making ledges from upside-down L-shaped indentations in a bucket is as easy to injection mold as common prior art plastic buckets. Because there are no extra parts (like metal rods), a paint manufacturer could sell their product in the bucket. The wiping/resting ledges average 6.25″ wide, so one doesn't have to maneuver a brush to wipe it, like if the ledge were only the exact width of the brush.

Holding a bucket by prior-art style metal handle is the most stress-free way of holding a bucket. With my bucket there's lots of of room to dip a brush while hanging from the handle (because any bucket handle must lay substantially against the bucket side when not in use): This buckets handle is taller and flatter at the top than prior art buckets. A longer handle makes the buckets dipping area larger. Holding the flat handle is easier. [In contrast, prior art bucket openings are smaller/restrictive, and they often must be tilted to dip inside, which is strenuous on the wrist.] A 4″ painting grid can fit in my bucket because of the square lip and close-to-the-top first ledge. The bucket is as easy to use by both left-handed and right-handed users (just turn the bucket around). The bucket can be stacked one inside another as closely as prior art plain round buckets, which is a most important factor in reducing shipping costs and shelf space.

### BRIEF DESCRIPTION OF THE DRAWINGS

PRIOR ART FIG. X1 is Bird's bucket in use, front view.

PRIOR ART FIG. X2 is Bird's bucket in use as a ledge, top view.

FIG. 1 is the embodiment, user dipping brush & hung, front view.

FIG. 2 is the embodiment, prior art brush laying on a ledge, front view.

FIG. 3 is the embodiment, user gripping ledge & handle, front view.

FIG. 4 is the embodiment with a prior art brush, top view.

FIG. 5 is the embodiment gripped & w/brush, front view.

FIG. 6 is the embodiment with a prior art roller grid, top view.

FIG. 7 is the embodiment, RHS view.

FIG. 8 is the embodiment, LHS view.

FIG. 9 is the embodiment, front view.

FIG. 9D1 is a detail of the embodiment shown in FIG. 9.

FIG. 9D2 is an alternative lip embodiment, same view as FIG. 9D1.

FIG. 10A is a substantially rectangular-bottomed embod., bottom view.

FIG. 10B is a substantially elliptical-bottomed embod., bottom view.

FIG. 11 is the embodiment, top view.

FIG. 12 shows two buckets stacked one inside another, front view.

### BRIEF DESCRIPTION OF THE NOTATIONS

(L=left, R=right, F=front, B=back, M=middle, C=corner)
1 lip
2 horizontal cross-section
3 cross-section longer sides
4 cross-section shorter sides
5 wider walls
6 narrower walls
7 ledges
8 ledge edge
9 bottom
10 rim
11 prior art handle supports
12 prior art handle

### DETAILED DESCRIPTION OF THE INVENTION

### 1. Description of one Embodiment of the Invention

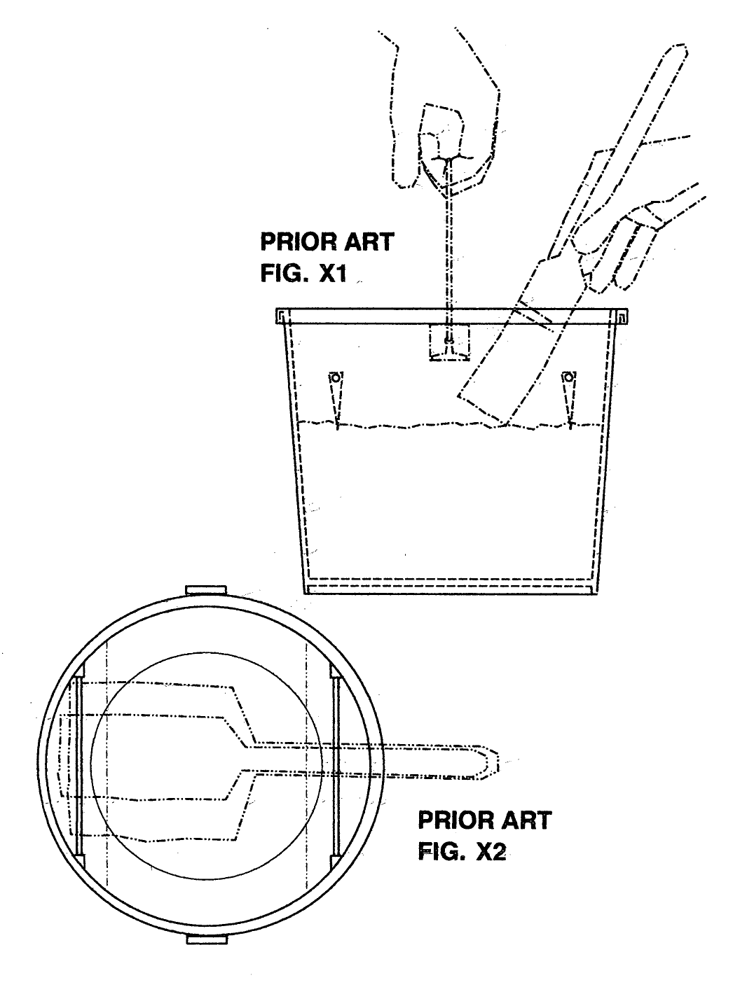

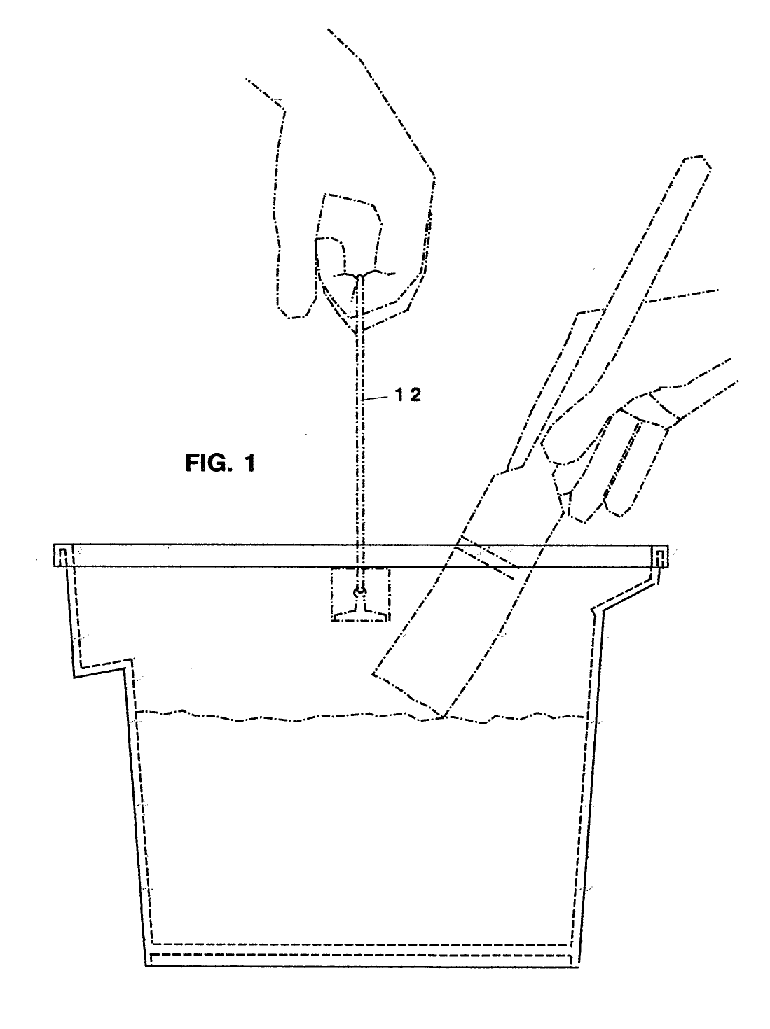

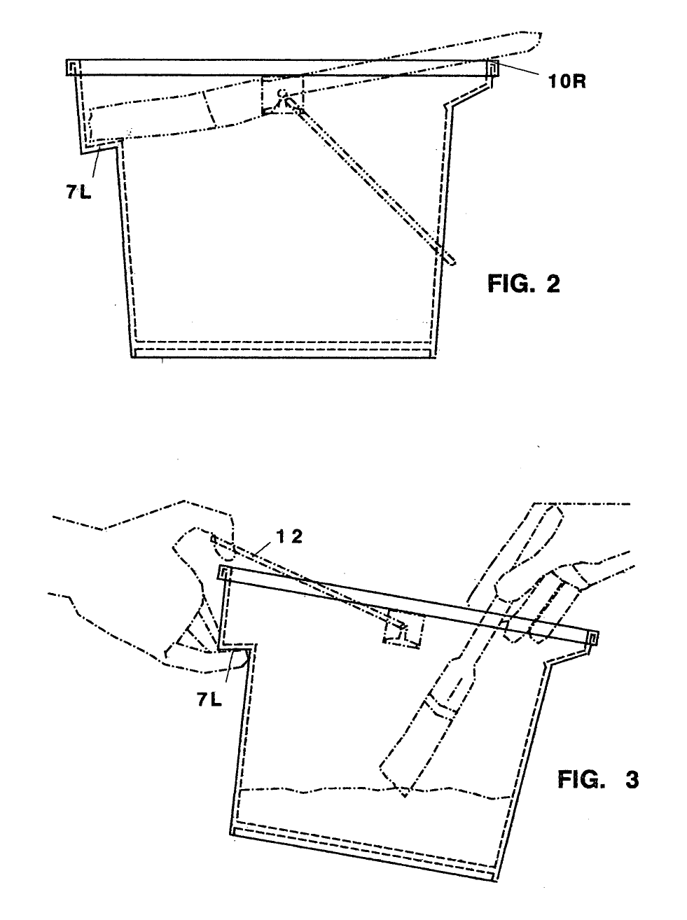

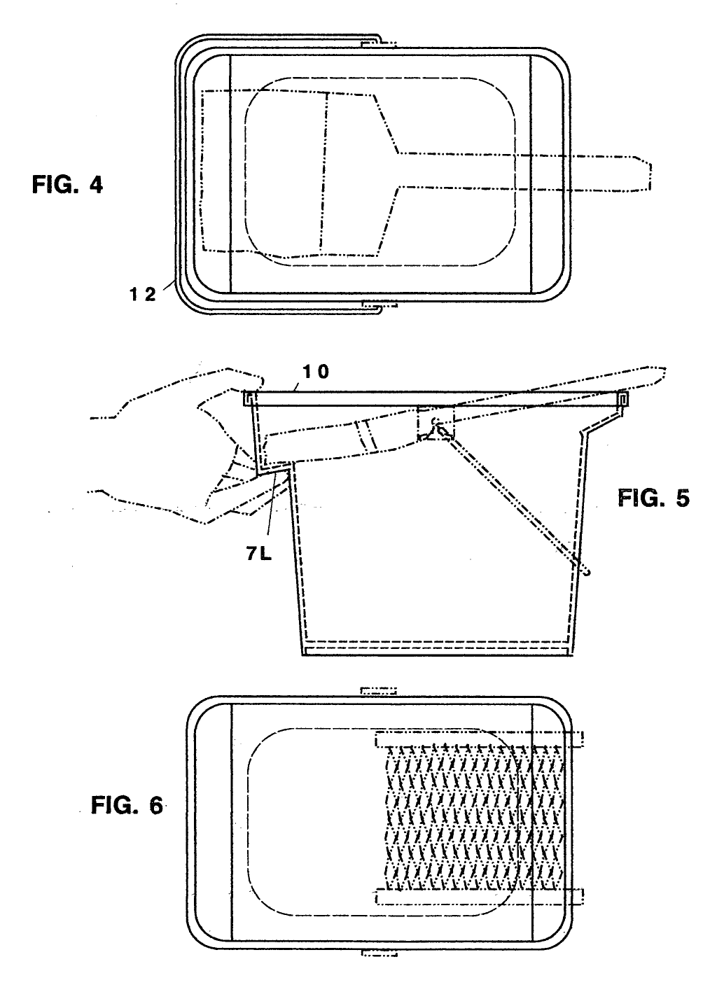

FIGS. 1-6 show an embodiment of the invention in various uses. FIG. 1 is the embodiment, front view, user dipping brush in the wide open bucket. The bucket is hung from a users hand. The top of handle 12 is about 1″ farther away from the buckets rim than a prior art bucket of the same gallon-holding size. This is because the lip is larger than other gallon-sized prior art round buckets. The handle (best shown in FIG. 4 as notation 12) is substantially retangular, like the bucket lip. The handle is longer so it can lay substantially against bucket walls when not in use (like in FIG. 2). The longer handle adds to the open area for brush dipping. Its flat top-portion is more comfortable on the hand to grip than round-topped handles.

FIG. 2 is the embodiment with a prior art brush laying on a ledge and the lips rim, front view. The brush bristles lay on second ledge 7L and the handle lays on opposite-side lip rim 10R. FIG. 3 is the embodiment with a user gripping under second ledge 7L and handle 12, front view. The user is tilting the bucket and dipping a brush to get the last of the paint. FIG. 4 is the embodiment with a prior art 4″ brush, top view.

FIG. 5 is the embodiment gripped by a user between bucket second ledge 7L and lip rim 10 (brush on ledge) front view. FIG. 6 is the embodiment with a prior art 4″ roller grid, top view. With substantially straight shorter lip sides, the grid fits nicely in/on the bucket.

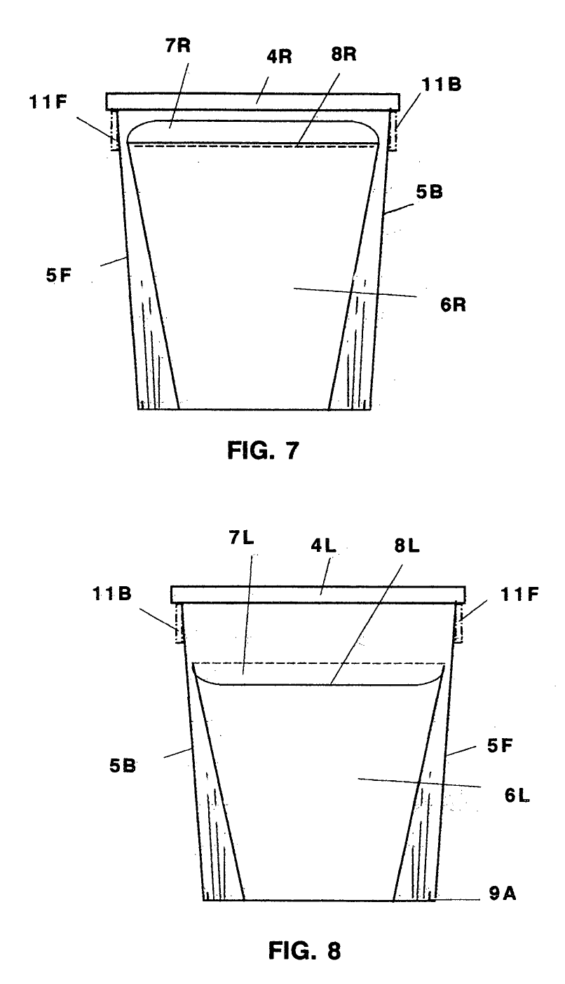

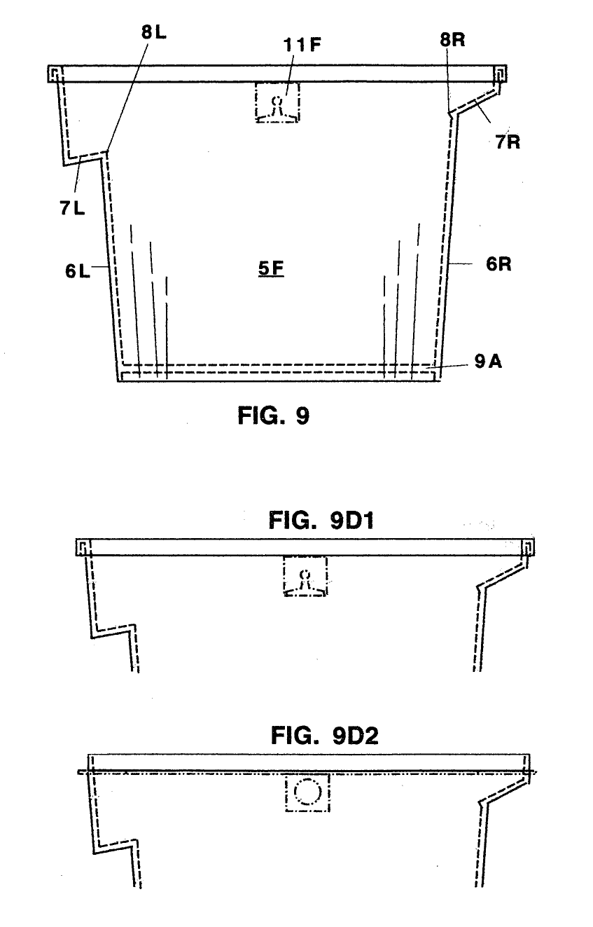

FIG. 7 is the embodiment, RHS view. Handle supports 11F and 11B, horizontal cross section/lip shorter side 4R, RHS narrow wall 6R, wider walls 5F and 56, first ledge 7R, and first ledge edge 8R are noted. FIG. 8 is the embodiment, LHS view. Handle supports 11F and 11B, horizontal cross section/lip shorter side 4L, LHS narrow wall 6L, wider walls 5F and 5B, second ledge 7L, second ledge edge 8L, and bottom 9A are noted. FIG. 9 is the embodiment, front view. Handle support 11F, narrow walls 6L and 6R, wider wall 5F, second ledge 7L, first ledge 7R, second ledge edge 8L, first ledge edge 8R, and bottom 9A are noted. FIG. 9D1 is a detail of the embodiment shown in FIG. 9. Handle attachment ends, that hook into bucket, can be made in a variety of prior art ways (none shown). The supports can be made integral with the lip. FIG. 9D2 is an alternative lip embodiment, same view as FIG. 9D1. FIG. 9D2 shows a prior art lip like that used in a round-cornered rectangular-lipped container, like Tupperware®. This figure shows a prior art knob for a loop-ended wire handle (wire ends curve around knob)[not shown]. Other prior art ways of supporting a handle are not discussed.

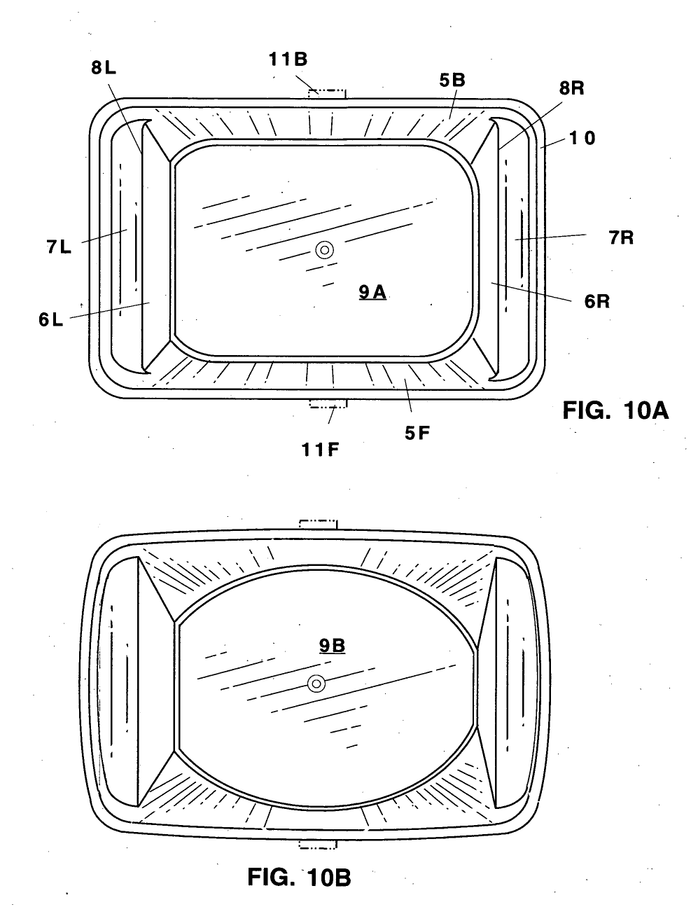

FIG. 10A is a substantially round-cornered rectangular-bottomed embodiment, bottom view. The bottoms center indicates a circular injection-molded gate site. Handle supports 11F and 11B, narrow walls 6L and 6R, wider walls 5F and 5B, second ledge 7L, first ledge 7R, second ledge edge 8L, first ledge edge 8R, and bottom 9A are noted. FIG. 10B shows a substantially elliptical-bottom 9B embodiment, bottom view. Its elliptical-bottom shape adds an aesthetic ∫round” appearance.

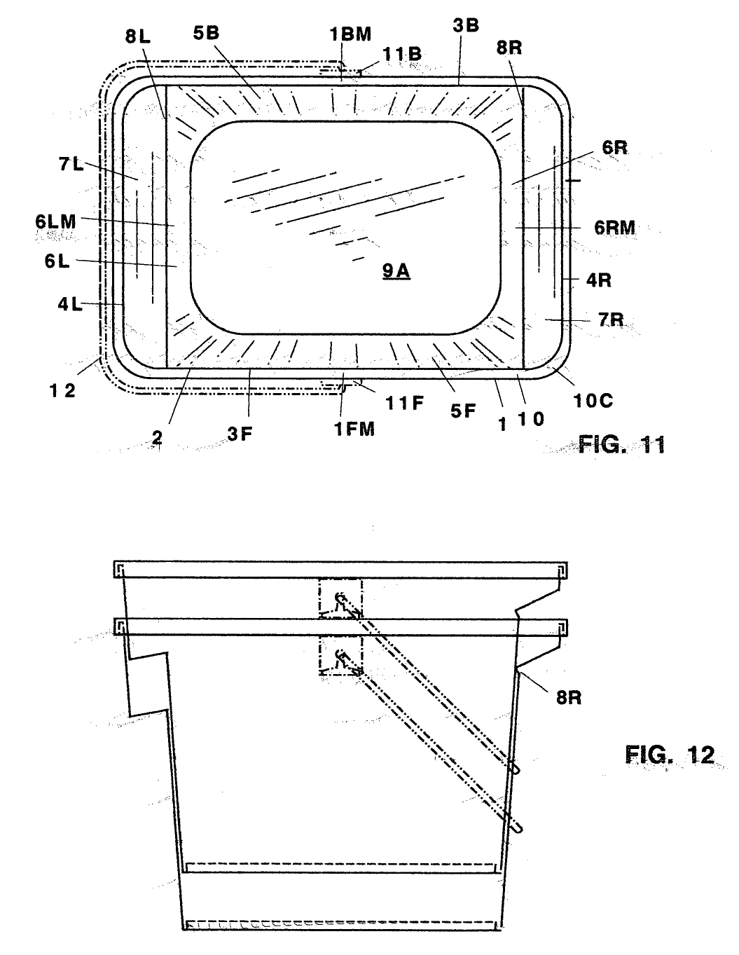

FIG. 11 is the embodiment, top view. The bucket has lip 1 and horizontal cross-section 2. The cross-section is substantially rectangular with rounded corners, like corner 10C. The cross-section is shown as an inside-bucket lip line. The cross-section has opposite-side longer sides 3F and 3B. The cross-section has opposite-side shorter sides 4L and 4R. The bucket extends downward from the lip.

The bucket has opposite-side wider side walls 5F and 5B, each positioned beneath opposite-side lip longer sides. The bucket has opposite-side narrower side walls 6L and 6R, each positioned beneath opposite-side lip shorter sides. The bucket has two opposite side ledges 7L and 7R. The ledges each have a substantially straight horizontal edge (edge 8L and 8R) positioned inside the bucket. The ledges each substantially position beneath and substantially parallel with a shorter sides of the lip (best seen in FIG. 9).

A substantial portion of each ledge edge protrudes at least ¾ inch horizontally centrally into the bucket from a corresponding lip shorter side. In this embodiment, each ledge protrudes, about 1.2″ horizontally centrally into the bucket. The ledges are substantially integrally formed from the buckets narrower side walls, appearing as substantially horizontally-elongated upside-down L-shaped indentations in the narrower side walls (best seen in FIG. 9).

The bucket has circumferentially enclosing side walls 5F, 5B, 6L, and 6R. The bucket has bottom 9 fixedly attached to substantially the bottom edges of all the side walls. The side walls together integrally form circumferentially enclosing side walls. All the side walls have bottom edges. Bottom 9 is fixedly attached substantially to all side wall bottom edges. So together, the bottom and side walls integrally form a container. The side walls are shown (best seen in FIG. 9) extending like 0.2″ below bucket bottom, to improve bucket stability. Such extensions would likely be considered feet rather than walls. The bucket substantially is a single molded unit that can contain liquid. Bucket measurements can be: lip 10″×7″, bottom: 7″×5.5″, & bucket height: 7″.

The bucket lip has a rim 10, which is the top-most portion of lip 1. In this embodiment, the lip is flat on top. The ledges are right hand side first ledge 7R and a left-hand side second ledge 7L. [Best seen in FIG. 9, the left-hand side ledge edge 8L is substantially 0.5″ to 1.5″ down from the lip rim. The right-hand side ledge edge 8R is substantially 1.5″ to 2.5″ down from the lip rim.] The bucket bottom has a horizontal cross-section substantially rectangular with rounded corners.

The lips longer sides each have a horizontal middle (middle 1FM and 2BM). In use, the bucket should include a pair of prior art integrally-formed handle supports, like handle supports 11F and 11B. The supports position slightly beneath/directly beneath the lip at corresponding opposite-side horizontal middles 1FM and 1BM. Attached thereto is prior art wire metal handle, like handle 12. The supports are each of a size and shape to support one of two sides of a prior art style wire handle.

The bucket has a downwardly tapered form to be easily removable from a molding tool. A 5% total grade (includes both sides) is average for buckets that stack within each other. The bucket is of a downwardly tapered form to be stackable one said bucket substantially inside an identical bucket.

FIG. 12 shows two buckets stacked one inside another. Bucket walls are drawn thick in other figures for clarity. Actual wall thickness can average 2 mm. The bottom edge of the handle supports rest over the rim of the bucket beneath it, as is the case with many prior art plastic round buckets. (Note that the small rib, at first ledge edge 8R must be small.) The handle can have a tube over the top flat portion to thicken handle for holding.

The bucket may be injection, vaccuum-, blow-, or roto-molded. Or other. Though demonstrated for paint, my buckets utility is of benefit for liquids like wallpaper paste, as well as more viscous materials. In example, a smaller bucket of the same shape could be used for spackle (smaller bucket so spackle knife fits across from the second ledge to the opposite-side lip). The bucket can be used by right or left handed users by just turning the bucket around. Materials to make the invention include, but are not limited to be made from polypropylene or other plastics.

### 13. CONCLUSION

The invention provides a ledge for holding a brush, a ledge for brush wiping, and a rectangular, therein enlarged, area for brush dipping. The bucket can be a one-piece moldable bucket made from a 2-part tool (no slides needed). Buckets can be closely stacked, for saving shipping and shelf space. No other buckets, alone or in combination, recognize the ledge and dipping benefits produced by a substantially rectangular bucket. No other buckets alone or in combination, recognize the L-shaped ledges would allow buckets to be easily made and stacked.

I claim:

1. A bucket, having a lip, said lip having a horizontal cross-section having opposite-side longer sides, said cross-section having opposite-side shorter sides;
said bucket extending downward from said lip;
said bucket having opposite-side wider side walls each positioned beneath opposite-side said lip longer sides, said bucket having opposite-side narrower side walls each positioned beneath opposite-side said lip shorter sides, said bucket having two opposite side ledges, said ledges each having a substantially straight edge positioned inside said bucket, said ledges each substantially positioned beneath and substantially parallel with a said shorter sides of said lip;
a substantial portion of each said ledge edge protruding at least ¾ inch horizontally centrally into said bucket from a corresponding said lip shorter side;
each said ledge substantially integrally formed from a corresponding said narrower side wall;
said ledges appearing as substantially horizontally-elongated upside-down L-shaped indentations in said narrower side walls when viewed facing a said wider wall;
said walls integrally forming circumferentially enclosing side walls;
all said side walls having bottom edges;
said bucket having a bottom;
said bottom fixedly attached substantially to all said bottom edges; and
said bottom attached to said side walls integrally forming a container.

2. The bucket according to claim 1, wherein: said bucket substantially being a single molded unit that can contain liquid.

3. The bucket according to claim 1, wherein: said lip having a rim;
said ledges being a right hand side ledge and a left-hand side ledge, said left-hand side ledge edge being substantially 0.5″ to 1.5″ down from said lip rim; and said right-hand side ledge edge being substantially 1.5″ to 2.5″ down from said lip rim.

4. The bucket according to claim 1, wherein: said bottom having a horizontal cross-section substantially rectangular with rounded corners.

5. The bucket according to claim 1, wherein: said bottom having a horizontal cross-section substantially elliptical.

6. The bucket according to claim 1, further including a pair of prior art integrally-formed handle supports;
said lip longer sides each having a horizontal middle; and
each said handle support substantially positioned directly beneath said lip at opposite-side said horizontal middles, said supports each of a size and shape to support one of two sides of a prior art style wire handle.

7. The bucket according to claim 6 further including a prior art handle attached thereto.

8. The bucket according to claim 1, wherein: said bucket being of a downwardly tapered form to be easily removable from a molding tool.

9. The bucket according to claim 1, wherein: said bucket being of a downwardly tapered form to be stackable one said bucket substantially inside an identical bucket.

10. The bucket according to claim 1, wherein: said ledge protruding at least one inch horizontally centrally into said bucket

11. The bucket according to claim 1, wherein: said horizontal cross-section having rounded corners.

12. The bucket according to claim 1, wherein: said lip cross-section being substantially rectangular.
